(19) United States
(12) Patent Application Publication
(10) Pub. No.: US 2019/0195122 A1
(43) Pub. Date: Jun. 27, 2019

(54) TURBOCHARGER HAVING VARIABLE COMPRESSOR TRIM

(71) Applicant: BorgWarner Inc., Auburn Hills, MI (US)

(72) Inventors: Andrew TAYLOR, Mirfield (GB); Pawel BAKULA, Leeds (GB); Nathan MCARDLE, Baildon (GB)

(21) Appl. No.: 16/329,406

(22) PCT Filed: Aug. 31, 2017
(86) PCT No.: PCT/US2017/049577

§ 371 Date: Feb. 28, 2019

Related U.S. Application Data
(60) Provisional application No. 62/413,003, filed on Oct. 26, 2016.
(60) Provisional application No. 62/382,935, filed on Sep. 2, 2016.

(51) Int. Cl. F02B 37/22; F01D 17/14; F02C 6/12; F04D 27/02; F04D 29/42; F04D 29/46

(52) U.S. Cl. CPC F02B 37/225; F01D 17/146; F02C 6/12; F04D 27/0253; F05D 2260/53; F04D 29/464; F01D 17/143; F05D 2220/40; F05D 2250/51; F04D 29/4213

(57) ABSTRACT

A turbocharger includes a compressor and an airflow adjustment assembly. The airflow adjustment assembly includes a plurality of guide vanes. Each of the plurality of guide vanes has a guide tip and a guide base spaced from the guide tip along an axis. The guide tips define a vane diameter (VD) less than the inlet diameter (ID) and perpendicular to the axis. The airflow adjustment assembly further includes a sliding ring and a plurality of connecting rods. The sliding ring is configured to be axially movable along the axis. Additionally, the plurality of connecting rods are axially moveable along the axis when the sliding ring moves axially along the axis, thereby selectively increasing and/or decreasing the vane diameter (VD) when the sliding ring moves axially along the axis.

### BACKGROUND OF THE INVENTION

### 1. Field of the Invention

The invention generally relates to a compressor for use in a turbocharger of a vehicle.

### 2. Description of the Related Art

Turbochargers receive exhaust gas from an internal combustion engine and deliver compressed air to the internal combustion engine. Turbochargers are used to increase power output of the internal combustion engine, lower fuel consumption of the internal combustion engine, and reduce emissions produced by the internal combustion engine. Delivery of compressed air to the internal combustion engine by the turbocharger allows the internal combustion engine to be smaller, yet able to develop the same or similar amount of horsepower as larger, naturally-aspirated internal combustion engines. Having a smaller internal combustion engine for use in a vehicle reduces the mass and aerodynamic frontal area of the vehicle, which helps reduce fuel consumption of the internal combustion engine and improve fuel economy of the vehicle.

Typical turbochargers include a turbine housing defining a turbine housing interior, a turbine wheel disposed within the turbine housing interior, and a shaft coupled to and rotatable by the turbine wheel. Typical turbochargers also include a compressor housing defining a compressor housing interior and a flow path. The flow path fluidly couples the interior of the compressor housing with the internal combustion engine. Typical turbochargers further include a compressor wheel disposed within the interior of the compressor housing and coupled to the shaft. The compressor wheel is rotatable by the shaft for delivering the compressed air to the internal combustion engine through the flow path. Specifically, energy from exhaust gas from the internal combustion engine, which would normally be wasted energy, is used to drive the turbine wheel, which is used to drive the shaft and, in turn, the compressor wheel to the deliver compressed air to the internal combustion engine.

The compressor has a trim which influences the amount of airflow through the compressor wheel. As such, depending on the desired performance of the internal combustion engine, typical compressor wheels are designed to deliver a target airflow to the internal combustion engine. In typical turbochargers, the airflow through the compressor wheel and to the internal combustion engine may also be influenced by other factors.

Typical compressors in single stage turbochargers have a constant trim which limits airflow through the compressor wheel to a constant flow. However, more recent compressors may include a variable compressor trim. Known variable compressor trims include overlapping single-layer vanes which can lead to undesirable leakage of air into the compressor housing.

As such, there remains a need to provide for an improved variable compressor trim for use in a turbocharger.

### SUMMARY OF THE INVENTION AND ADVANTAGES

A turbocharger for receiving exhaust gas from an internal combustion engine and for delivering compressed air to the internal combustion engine includes a turbine housing which defines a turbine housing interior. The turbocharger also includes a turbine wheel disposed within the turbine housing interior for receiving the exhaust gas from the internal combustion engine. A turbocharger shaft is coupled to and rotatable by the turbine wheel, and the turbocharger shaft extends along an axis that extends longitudinally through the turbine housing interior. Moreover, the turbocharger includes a compressor housing defining an interior, with the compressor housing having an air inlet portion spaced from the turbocharger shaft and disposed about the axis, and the air inlet defines an inlet diameter (ID) perpendicular to the axis.

The turbocharger also includes a compressor wheel disposed within the interior of the compressor housing and coupled to the turbocharger shaft. The compressor wheel is rotatable by the turbocharger shaft and is disposed between the air inlet portion and the turbine wheel for delivering compressed air to the internal combustion engine. Finally, the turbocharger includes an airflow adjustment assembly.

The airflow adjustment assembly includes a plurality of guide vanes at least partially disposed within the interior of the compressor housing. Each of the plurality of guide vanes has a guide tip and a guide base spaced from the guide tip along the axis. Moreover, each of the guide bases are pivotably coupled to the air inlet portion. The guide tips define a vane diameter (VD) less than the inlet diameter (ID) and perpendicular to the axis. The airflow adjustment assembly further includes a sliding ring at least partially disposed within the interior, and a plurality of connecting rods at least partially disposed within the interior. The sliding ring is configured to be axially movable along the axis. Each of the connecting rods are disposed between and coupled to one of the guide vanes at the guide base and the sliding ring.

Additionally, the plurality of connecting rods are axially moveable along the axis when the sliding ring moves axially along the axis, thereby selectively increasing and/or decreasing the vane diameter (VD) when the sliding ring moves axially along the axis.

Accordingly, the plurality of guide vanes allow the compressor trim to be adjusted when desired. The compressor trim is defined as the outlet diameter of the airflow adjustment assembly, which is also known as the vane diameter. Adjusting the compressor trim or vane diameter allows the turbocharger to achieve higher pressure ratios at low engine speeds by changing the diameter of the compressor trim. This allows a single stage compressor to perform at a similar performance and efficiency of a multiple stage compressor while implementing the space saving advantage of the single stage compressor. Moreover, providing a support ring coupled to the airflow adjustment assembly allows ease of installation and repair inside the compressor housing.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic partial cross-section illustration of a turbocharger;

FIG. 2 is perspective view of a compressor removed from the turbocharger;

FIG. 3 is a perspective view of an airflow adjustment assembly removed from the compressor;

FIG. 4 is a perspective view of a guide vane of the airflow adjustment assembly;

FIG. 5 is a bottom plan view of the guide vane of the airflow adjustment assembly;

FIG. 6 is a side view of the guide vane of the airflow adjustment assembly;

FIG. 7 is a top plan view of the guide vane of the airflow adjustment assembly;

FIG. 8 is cross-sectional view of the compressor including a compressor housing and a sliding ring in a first position;

FIG. 9 is a cross-sectional view of the compressor including the compressor housing and the sliding ring in a second position;

FIG. 10 is a schematic partial cross-section illustration of a turbocharger according to another embodiment;

FIG. 11 is perspective view of a compressor removed from the turbocharger according to the embodiment illustrated in FIG. 10;

FIG. 12A is a perspective view of an airflow adjustment assembly removed from the compressor;

FIG. 12B is an opposite perspective view of the airflow adjustment assembly removed from the compressor according to the embodiment illustrated in FIG. 10;

FIG. 13 is a perspective view of a portion of the airflow adjustment assembly including a yoke and a cross-shaft according to the embodiment illustrated in FIG. 10;

FIG. 14 is a side perspective view of the yoke and cross-shaft according to the embodiment illustrated in FIG. 10;

FIG. 15 is a perspective view of a guide vane of the airflow adjustment assembly according to the embodiment illustrated in FIG. 10;

FIG. 16 is a bottom plan view of the guide vane of the airflow adjustment assembly according to the embodiment illustrated in FIG. 10;

FIG. 17 is a side view of the guide vane of the airflow adjustment assembly according to the embodiment illustrated in FIG. 10;

FIG. 18 is a top plan view of the guide vane of the airflow adjustment assembly according to the embodiment illustrated in FIG. 10;

FIG. 19 is cross-sectional view of the compressor including a compressor housing and a sliding ring in a first position according to the embodiment illustrated in FIG. 10; and

FIG. 20 is a cross-sectional view of the compressor including the compressor housing and the sliding ring in a second position according to the embodiment illustrated in FIG. 10.

### DETAILED DESCRIPTION OF THE INVENTION

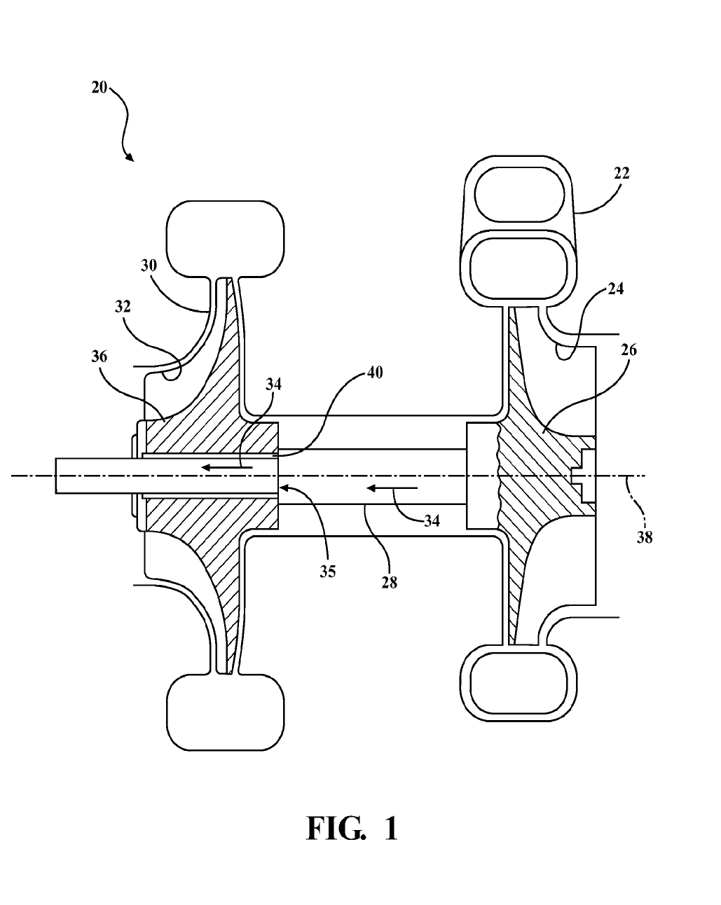

With reference to the embodiment illustrated in FIGS. 1-9, wherein like numerals indicate like parts throughout the several views, a turbocharger 20 is generally shown in FIG. 1. The turbocharger 20 receives exhaust gas from an internal combustion engine and delivers compressed air to the internal combustion engine. The turbocharger 20 includes a turbine housing 22 defining a turbine housing interior 24. The turbine housing 22 receives and directs exhaust gas from the internal combustion engine. The turbocharger 20 includes a turbine wheel 26 within the turbine housing interior 24 for receiving the exhaust gas from the internal combustion engine. Specifically, the exhaust gas from the internal combustion engine is used to drive the turbine wheel 26. The turbocharger 20 includes a shaft 28 coupled to and rotatable by the turbine wheel 26. Specifically, the turbine wheel 26 is driven by the exhaust gas from the internal combustion engine, which, in turn, rotates the shaft 28. The shaft 28 extends along an axis 38 that extends longitudinally through the turbine housing interior 24.

The turbocharger 20 includes a compressor housing 30 defining an interior 32 of the compressor housing 30 and a flow path 34. The interior 32 of the compressor housing 30 receives and directs air to the internal combustion engine. The flow path 34 fluidly couples the interior 32 of the compressor housing 30 with the internal combustion engine. The compressor housing 30 includes an air inlet portion 35 which is spaced apart from the shaft 28 and is disposed about the axis 38. The air inlet defines an inlet diameter (ID) which is disposed perpendicular to the axis 38. The turbocharger 20 includes a compressor wheel 36 disposed within the interior 32 of the compressor housing 30 and coupled to the shaft 28. The compressor wheel 36 is disposed between the air inlet portion 35 and the turbine wheel 26. The compressor wheel 36 is rotatable by the shaft 28 for delivering the compressed air to the internal combustion engine through the flow path 34.

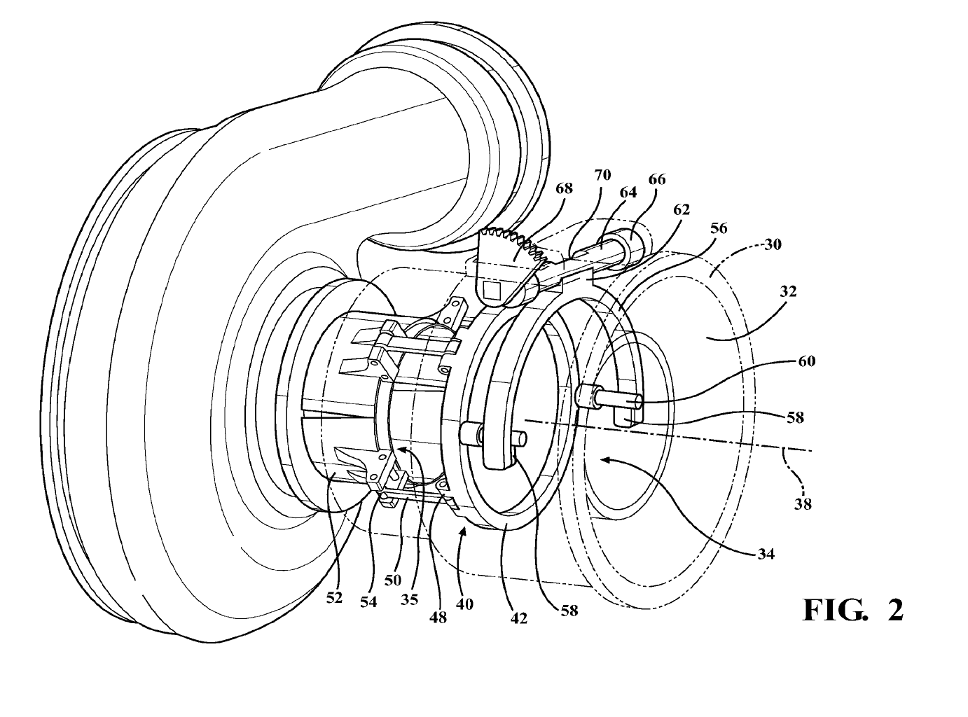

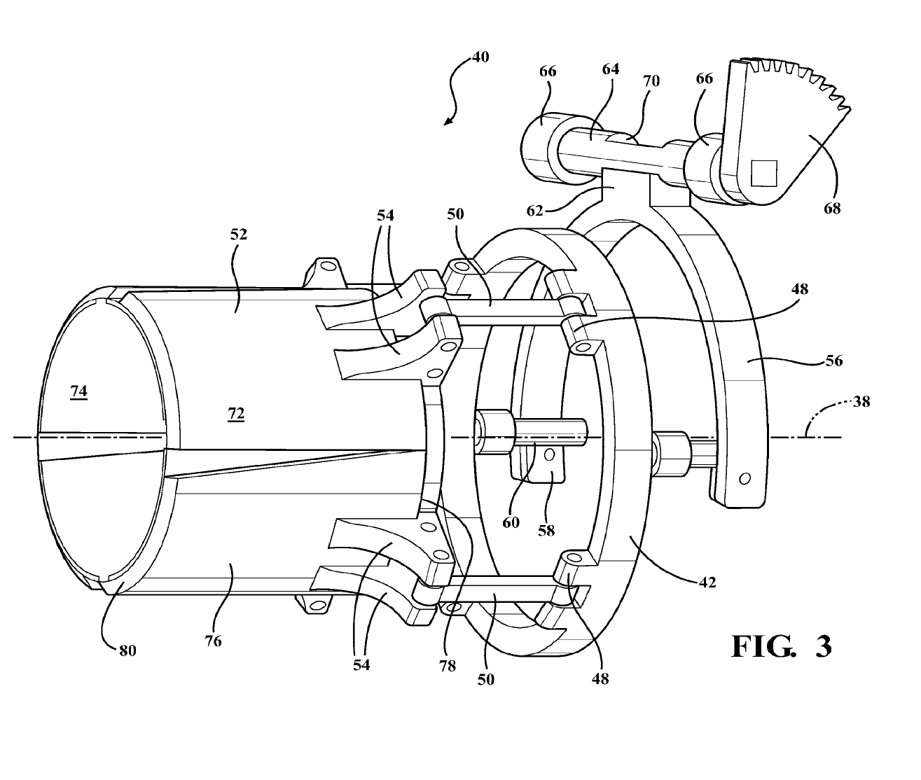

Referring now to FIGS. 2 and 3, the turbocharger 20 also includes an airflow adjustment assembly 40. The airflow adjustment assembly 40 may be disposed at least partially within the interior 32 of the compressor housing 30. It is also contemplated that certain components of the airflow adjustment assembly 40 may be disposed outside of the compressor housing 30. In the embodiment illustrated in FIG. 2, the entire airflow adjustment assembly 40 is disposed within the interior 32 of the compressor housing 30. Moreover, the flow path 34 is disposed parallel with the axis 38 and flows into the airflow adjustment assembly 40 at one end, flows through the airflow adjustment assembly 40 and exits the airflow adjustment assembly 40 at an opposite end where the air continues to flow into the compressor housing 30 towards the internal combustion engine.

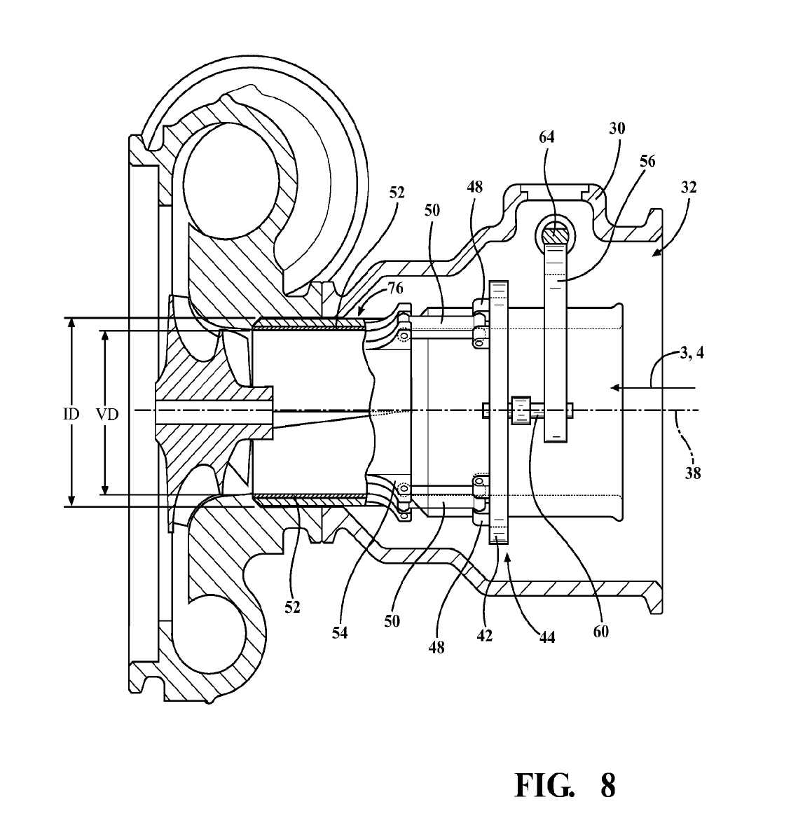

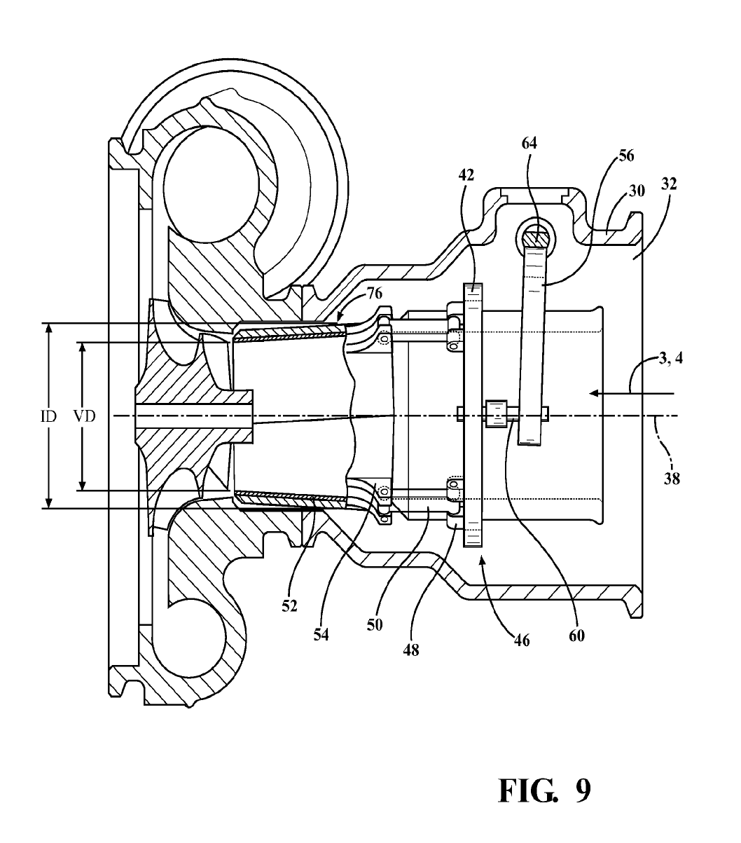

The airflow adjustment assembly 40 includes a sliding ring 42 which is at least partially disposed within the interior 32 of the compressor housing 30. The sliding ring 42 may be comprised of aluminum, steel, a plastic polymer or other material as known by one of ordinary skill in the art. The sliding ring 42 is configured to be axially movable between a first position 44 where air is not restricted from flowing though the interior 32 of the compressor housing 30, and a second position 46 where air is at least partially restricted from flowing through the interior 32 of the compressor housing 30 along the axis 38. As illustrated in the embodiment shown in FIGS. 8 and 9, when the sliding ring 42 is moved towards the first position 44, the sliding ring 42 moves along the axis 38 in the opposite direction of the flow path 34. Moreover, when the sliding ring 42 is moved towards the second position 46, the sliding ring 42 moves along the axis 38 in the same direction as the flow path 34.

Referring again to FIGS. 2 and 3, the sliding ring 42 has a generally circular, ring-like shape having an aperture in the center. The flow path 34 is configured to be disposed through the aperture of the sliding ring 42. In the embodiment illustrated in FIGS. 2 and 3, the sliding ring 42 has a generally flat first surface and second surface which are connected by a curved outer and inner surface forming the ring shape. As shown in FIGS. 2 and 3, the top surface, bottom surface, inner surface, and outer surface generally have a similar width. However, it is contemplated that the widths of any of the surfaces may be larger or smaller than any other surface width of the sliding ring 42. In the embodiment shown in FIG. 3, the sliding ring 42 is disposed perpendicular to the axis 38 such that the axis 38 is disposed through the aperture in the center of the sliding ring 42. However, it is contemplated that the sliding ring 42 may be various other shapes and/or orientations configured to be axially moveable along the axis 38.

Referring again to the embodiment illustrated in FIG. 3, the sliding ring 42 may include at least one, and as illustrated in FIG. 3, a plurality of connecting prongs 48 which extend from the second surface of the sliding ring 42. As such, it is contemplated that the connecting prongs 48 may be made of the same material as the sliding ring 42 or may be made of a different material including but not limited to steel, aluminum, or a plastic polymer as known by one of ordinary skill in the art. In the embodiment shown in FIG. 3, the connecting prongs 48 extend the entire width of the bottom surface, however, various configurations have been contemplated. The connecting prongs 48 illustrated in FIG. 3 are disposed in pairs about the bottom surface of the sliding ring 42, having a space between each pair. A connecting rod 50 is configured to be disposed in the space between each pair of connecting prongs 48. It is contemplated that a fastener is disposed through the pair of connecting prongs 48 and through the connecting rod 50 to secure the connecting rod 50 to the sliding ring 42. However, it is also contemplated that the connecting rod 50 and the sliding ring 42 may be coupled in various other ways, as known by one of ordinary skill in the art. In the embodiment illustrated in FIG. 3, the sliding ring 42 includes four pairs of connecting prongs 48 corresponding to four connecting rods 50; however, any number of connecting prongs 48 and/or connecting rods 50 may be implemented in the airflow adjustment assembly 40.

The connecting rods 50 are at least partially disposed within the interior 32 of the compressor housing 30 and are configured to move in the direction opposite the flow path 34 when the sliding ring 42 is moved to the first position 44 and move in the same direction as the flow path 34 when the sliding ring 42 is moved to the second position 46. More specifically, the connecting rods 50 are axially movable along the axis 38 when the sliding ring 42 moves axially along the axis 38. As illustrated in the embodiment shown in FIG. 3, the connecting rods 50 have a generally bar-shaped main section having a circular connecting portion on each end. The circular portions are configured to allow the fastener to couple a first circular portion to the connecting prongs 48 of the sliding ring 42. On the opposite end of the connecting rod 50 is another circular portion which may be similar or identical to the first circular portion and is configured to pivotally couple the connecting rod 50 to a guide vane 52. Again, a fastener may be disposed through the circular portion to secure the connecting rod 50 and the guide vane 52. The connecting rods 50 may be comprised of steel, aluminum, or another material having sufficient strength to couple the sliding ring 42 to the guide vane 52 of the air flow adjustment assembly.

As illustrated in the embodiments shown in FIG. 3, the connecting rods 50 extend from the sliding ring 42 to the guide vane 52 and are configured to define a space between the sliding ring 42 and the guide vanes 52. In the embodiment illustrated in FIG. 3, the airflow adjustment assembly 40 includes four connecting rods 50, however it is contemplated that more or fewer connecting rods 50 may be disposed between the sliding ring 42 and the guide vanes 52. As additionally illustrated in the embodiment shown in FIG. 3, a single connecting rod 50 is coupled to each guide vane 52. However, it is additionally contemplated that multiple connecting rods 50 may be coupled to each guide vane 52 as desired by one of ordinary skill in the art.

Referring again to the embodiment shown in FIG. 3, the connecting rods 50 are coupled to the guide vanes 52 at a connecting protrusion 54 of the guide vane 52. As illustrated in FIG. 3, the connecting protrusion 54 is comprised of a pair of protrusions configured to have the connecting rod 50 disposed between the pair of protrusions. The fastener is then disposed through each protrusion and the circular portion of the connecting rod 50 to pivotally couple the guide vane 52 to the connecting rod 50. Various other configurations have also been contemplated which allow the connecting rod 50 and the guide vane 52 to be pivotally coupled to one another without departing from the spirit of the invention. Moreover, it is contemplated that the sliding ring 42 and the guide vane 52 may be coupled to one another using another mechanism without departing from the spirit of the invention.

The sliding ring 42 is additionally coupled to a cradle 56 which is at least partially disposed with the interior 32 of the compressor housing 30. As illustrated in FIGS. 2 and 3, the cradle 56 may have a generally semi-circle shape and is disposed in the direction opposite the direction of airflow from the sliding ring 42. The cradle 56 is pivotally coupled to the sliding ring 42 and configured to move the sliding ring 42 axially along the axis 38 between the first position 44 and the second position 46. It is contemplated that the cradle 56 may be a variety of other shapes or configurations configured to be pivotally coupled to the sliding ring 42 as known by one of ordinary skill in the art. The cradle 56 is typically comprised of the same material as the sliding ring 42 such as steel, aluminum or aluminum alloy, or a plastic polymer. However, the cradle 56 may be comprised of any other material as desired by one of ordinary skill in the art.

As shown in the embodiment illustrated in FIG. 3, the cradle 56 has a coupler 58 disposed on each distal end of an inside surface of the cradle 56. Each of the couplers 58 are configured to engage a connecting pin 60 which pivotally couples the sliding ring 42 and the cradle 56. It is contemplated that the coupler 58 is configured to allow the cradle 56 to tilt in a direction opposite the direction of the flow path 34 to move the sliding ring 42 from the first position 44 to the second position 46. More specifically, a top portion of the cradle 56 which is disposed along the semi-circle between the two distal ends of the cradle, is configured to move in the direction opposite the direction of the flow path 34 while the ends of the cradle 56 move in the direction of the flow path 34 to move the connecting pins 60 which move the sliding ring 42 from the first position 44 to the second position 46.

Referring again to the embodiment illustrated in FIG. 3, the cradle 56 is coupled to the sliding ring 42 using the connecting pins 60 and the couplers 58. It is contemplated that two connecting pins 60 may couple the sliding ring 42 and the cradle 56 as illustrated in FIG. 3; however, more or less connecting pins 60 may be used as desired by one of ordinary skill in the art. As also illustrated in FIG. 3, the connecting pins 60 may be coupled to the sliding ring 42 through guide bushings. However, it is contemplated that the connecting pins 60 may be coupled to the sliding ring 42 using another method as known by one of ordinary skill in the art. It is also contemplated that the cradle 56 is coupled to the sliding ring 42 using another connection method other than the coupler 58/connecting pin 60 mechanism as described above, as known by one of ordinary skill in the art.

As illustrated in the embodiment shown in FIG. 3, the cradle 56 may include a rectangular tab 62 disposed approximately equidistant between the two distal ends of the cradle 56 along the semi-circle. The rectangular tab 62 is configured to engage a cross-shaft 64. The cross-shaft 64 may be composed of steel, aluminum or aluminum alloy, a plastic polymer, or any other material as known by one of ordinary skill in the art. As illustrated in the embodiment shown in FIG. 3, the cross-shaft 64 is disposed perpendicular to the axis 38 and is fixed to the rectangular tab 62 of the cradle 56. As additionally illustrated in the embodiment shown in FIG. 3, the cross-shaft 64 is typically a cylindrical rod having two ends. However, it is contemplated that the cross-shaft 64 may be rectangular, triangular, or any other shape as desired by one of ordinary skill in the art. It is also contemplated that, as illustrated in FIG. 3, the cylindrical rod portion of the cross-shaft 64 may have an indented portion 70. The indented portion 70 may extend around the entire circumference of the cross-shaft 64 or may only extend around a portion of the circumference of the cross-shaft 64, as illustrated in FIG. 3. The cradle 56 may also be attached to the cross shaft 64 by having a through hole disposed in the cradle 56 which is configured to allow the cross-shaft 64 to pass directly through the cradle 56. Additionally, it is contemplated that the cross shaft 64 and the cradle 56 may be coupled using a clamp, an interference fit, or another connection method as known by one of ordinary skill in the art. Each end of the cross-shaft 64 may include a bushing 66 as illustrated in FIG. 3, or may include another connection feature allowing the cross-shaft 64 to be coupled to another device.

In the embodiment illustrated in FIG. 3, one end of the cross-shaft 64 includes an actuation gear 68. The actuation gear 68 is configured to be actuated by a gear assembly or other mechanism. When actuated, the actuation gear 68 is configured to rotate which in turn pulls the rectangular tab 62 of the cradle 56 such that the cradle 56 tilts and in turn moves the sliding ring 42 axially along the axis 38 from the first position 44 to the second position 46. The actuation gear 68 is typically comprised of steel, however the actuation gear 68 may be comprised of another material which has the strength required to rotate the cross-shaft 64, as known by one of ordinary skill in the art. As illustrated in the embodiment shown in FIG. 3, the actuation gear 68 has a rounded bottom portion which fans-out towards an upper portion which includes gear fingers for engaging another mechanism for actuation of the cross-shaft 64. However, it is contemplated that the actuation gear 68 may be any other shape or configuration as desired by one of ordinary skill in the art, including but not limited to a control lever which may be actuated by a pneumatic actuator or vacuum actuator or other actuator has known by one of ordinary skill in the art.

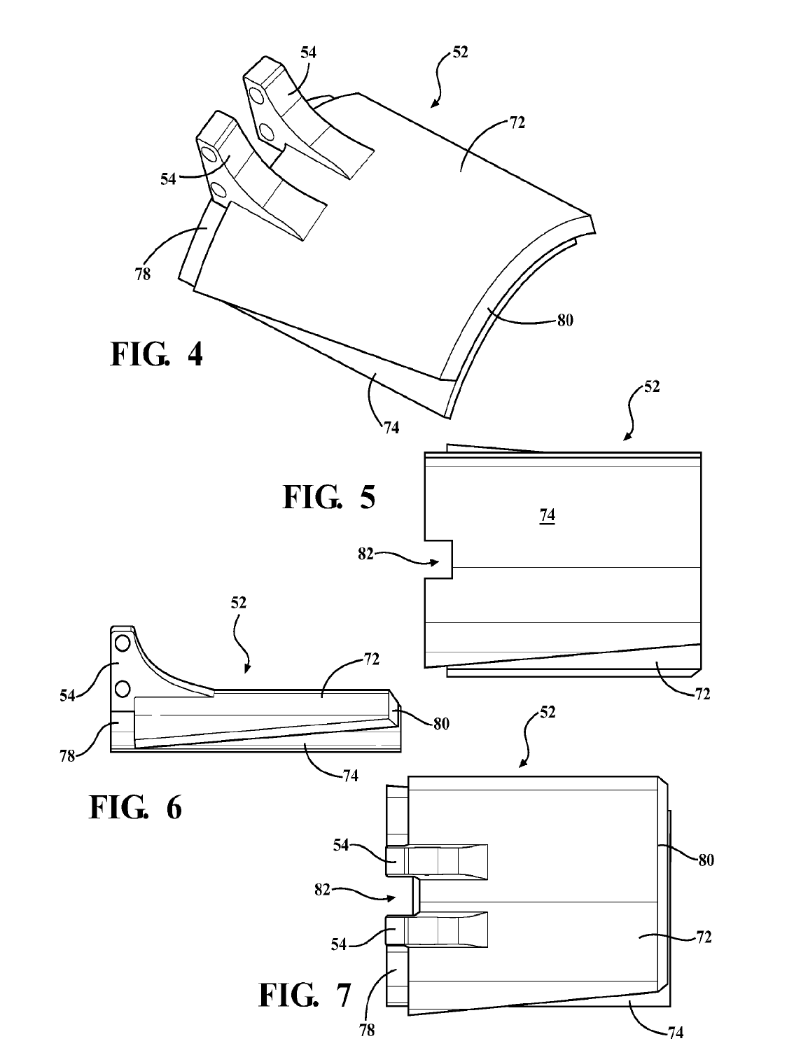

Referring now to the embodiment shown in FIGS. 4-7, the guide vanes 52 are at least partially disposed within the interior 32 of the compressor housing 30. The guide vanes 52 are generally comprised of steel, aluminum or aluminum alloy, a plastic polymer, or another material as known by one of ordinary skill in the art. Additionally, the guide vanes 52 have a separate outer surface 72 and an inner surface 74. However, it is also contemplated that the guide vanes 52 may be comprised of a single piece without departing from the spirit of the invention. It is contemplated that the outer surface 72 and inner surface 74 may be comprised of the same material or the outer surface 72 and the inner surface 74 may be comprised of different materials from one another. Both the outer surface 72 and the inner surface 74 of each guide vane 52 are configured to form a seal between each of the guide vanes 52 when the sliding ring 42 is in the first position 44 and when the sliding ring 42 is in the second position 46.

As illustrated in the embodiment shown in FIGS. 4-7, each guide vane 52 may be disposed within the interior 32 of the compressor housing 30. In the embodiment illustrated in the figures, the guide vanes 52 are curved slightly and disposed adjacent to one another, forming a guide drum 76. More specifically, the guide vanes 52 are curved such that the guide vanes 52 are disposed circumferentially about the axis 38 such that the guide vanes 52 form a circle having the axis 38 disposed through the center. In the embodiment illustrated in FIG. 3, four guide vanes 52 are disposed about the axis 38 forming the guide drum 76. However, it is contemplated that more or less guide vanes 52 may comprise the guide drum 76. Further, the inner surface 74s of the guide vanes 52 define an interior of the guide drum 76 which the flow path 34 flows through. Additionally, each of the guide vanes 52 have a guide tip 80 and a guide base 78, where each of the guide bases 78 are pivotally coupled to the air inlet portion 35. The guide base 78 is spaced from the guide tip 80 along the axis 38. The guide tips 80 of the guide vanes 52 define a vane diameter (VD). The vane diameter (VD) is measured from the inner surface 74 of one guide vane 52 to the inner surface 74 of an opposite guide vane 52 and is disposed perpendicular to the axis 38. Moreover, the vane diameter (VD) is less than the inlet diameter (ID). Additionally, the vane diameter (VD) is configured to be increased when the sliding ring 42 is moved to the first position 44 and to be decreased when the sliding ring 42 is moved to the second position 46.

Referring again to the embodiment illustrated in FIGS. 4-7, the inner surface 74 and outer surface 72 are separate surfaces and are disposed against each other, i.e. a top surface of the inner surface 74 is disposed against the bottom surface of the outer surface 72. Each of the inner surface 74 and the outer surface 72 have four sides. The first side, the second side, and the third side form three sides of a rectangle such that the first side and the second side are disposed parallel to one another and the third side is disposed at approximately a 90 degree angle to both the first and second side. The fourth side connects the first side and the second side, however, the fourth side is angled such that the first side has a length that is longer than the second side. Additionally, the first side includes may include an indent 82, as illustrated in FIGS. 4-7, which is configured to allow the connecting rod 50 to be disposed between the pair of connecting prongs 48 and coupled to the guide base 78. It is also contemplated that the guide base 78 may not include an indent 82 such that the connecting rod 50 is coupled to the guide vane 52 using another configuration.

As illustrated best in FIGS. 4, 5, and 7 the outer surface 72 and the inner surface 74 are arranged offset from one another such that the angled or fourth side of the outer surface 72 is matched up with the first side, or side parallel to the axis 38, of the inner surface 74. In other words, a portion of the inner surface 74 is visible from a top view, as illustrated in FIG. 7, and a portion of the outer surface 72 is visible when viewed from a bottom view, as illustrated in FIG. 6. This configuration allows the guide drum 76 to have an air-tight seal between guide vanes 52 when the sliding ring 42 is in the first position 44 and when the sliding ring 42 is in the second position 46. Additionally, this configuration may also provide an air tight seal between the guide vanes 52 when the sliding ring 42 is being moved from the first position 44 to the second position 46 and when the sliding ring 42 is being moved from the second position 46 to the first position 44. It is additionally contemplated that various other configurations of the guide vanes 52 may be implemented which provide an air-tight seal of the guide drum 76.

As best illustrated in FIGS. 4 and 6, the connecting protrusions 54 of the guide vane 52 are coupled to either the inner surface 74 or the outer surface 72 of the guide vane 52. However, it is also contemplated that the connecting protrusions 54 of the guide vane 52 are coupled to both the inner surface 74 and the outer surface 72 of the guide vane 52. As the connecting protrusions 54 are coupled to the connecting rods 50 and the sliding ring 42, the connecting protrusions 54 are configured to move both the inner surface 74 and the outer surface 72 of guide vane 52 as one piece when the sliding ring 42 is moved between the first position 44 and the second position 46. It is also contemplated that the inner surface 74 and the outer surface 72 could be moved separately if desired by one of ordinary skill in the art. Referring again to the embodiment illustrated in FIGS. 4 and 6, the inner surface 74 has a length which is longer than a length of the outer surface 72 such that the connecting prongs 48 are partially disposed on the inner surface 74 exclusively before also coupling the outer surface 72. It is additionally contemplated that various other configurations of the guide vane 52 and connecting prongs 48 may be implemented without departing from the spirit of the invention which allow the inner surface 74 and the outer surface 72 of the guide vanes 52 to be coupled to the connecting rods 50.

Referring now to the embodiment shown in FIGS. 8 and 9, in operation, the sliding ring 42 begins in the first position 44 shown in FIG. 8. When the sliding ring 42 is in the first position 44, the cradle 56 is disposed perpendicular to the axis 38 while the actuation gear 68 of the cross-shaft 64 is not actuated, as illustrated in FIG. 8. However, it is also contemplated that when the sliding ring 42 is in the first position 44, the cradle 56 may be disposed at an angle which is negative or positive relative to the axis. Additionally, when the sliding ring 42 is in the first position 44, the vane diameter (VD) is at its largest such that the air flow is not restricted in the flow path 34 through the airflow adjustment device. As illustrated in FIG. 8, the vane diameter (VD) is at its largest when the guide vanes 52 extend parallel to axis 38, however, it is also contemplated that the largest diameter may occur when the guide vanes 52 extend at an angle either above parallel to the axis 38. When desired, the actuation gear 68 may be activated by any mechanism as known by one of ordinary skill in the art. When the actuation gear 68 is activated, the cross-shaft 64 rotates which moves the cradle 56. The cradle 56 is moved or tilted to an angle which may be positive or negative relative to the axis 38. The angle may be a slight angle such as between 5 and 15 degrees or may be a bigger angle such as between 5 and 45 degrees. It is additionally contemplated that the cradle 56 may be rotated up to 90 degrees as desired by one of ordinary skill in the art. Moreover, it is also contemplated that any of the angles described may be negative angles with respect to the position of the cradle 56 when the sliding ring 42 is in the first position 44. When the cradle 56 is moved, the connecting pins 60 push the sliding ring 42 in a direction of the flow path 34 along the axis 38 and into the second position 46. In the second position 46, the sliding ring 42 engages the connecting rods 50 which allow the guide vanes 52 to pivot towards the center of the guide drum 76 such that the vane diameter (VD) is decreased. As illustrated in FIG. 9, when the sliding ring 42 is in the second position 46 the vane diameter (VD) is decreased from when the sliding ring 42 is in the first position 44 such that the air is at least partially restricted from flowing through the interior 32 of the compressor along the flow path 34. When the sliding ring 42 is in the first position 44 and when the sliding ring 42 is in the second position 46, the guide vanes 52 are sealed to one another such that no air escapes between the guide vanes 52 and all of the air entering the airflow adjustment assembly 40 moves through the airflow adjustment assembly 40 and exits the airflow adjustment assembly 40 to the compressor housing 30.

It is also contemplated that, when desired, the sliding ring 42 can be moved from the second position 46 to the first position 44. To achieve this, the actuation gear 68 of the cross-shaft 64 may be engaged by a mechanism which rotates the cross-shaft 64 to the position illustrated in FIG. 8. The cradle 56 is then moved to be perpendicular to the axis 38. The connecting pins 60 pull the sliding ring 42 to the first position 44. When the sliding ring 42 is moved to the first position 44, the connecting rods 50 are engaged and pivot the guide vanes 52 away from the center of the guide drum 76 until the vane diameter (VD) is at its largest. Moreover, it is contemplated that the vane diameter (VD) may be held in any position between the position corresponding with the first position 44 of the sliding ring 42 and the position corresponding with the second position 46 of the sliding ring 42.

One advantage of controlling the vane diameter (VD) is to achieve higher pressure ratios at a low engine speed. This improves the map width of a single compressor and increases the surge line of the compressor which allows better operating efficiency of the compressor and better intake throttling. By controlling the vane diameter (VD) in a single stage compressor by the method and apparatus described above, a similar performance of a multiple stage compressor may be achieved with the space saving advantages that come with a single stage compressor. The apparatus and method as described above also allow the turbocharger to achiever higher Exhaust Gas Recirculation (EGR) rates without impacting power rating. Additionally, the apparatus as described above may increase Low End Torque (LET) which would allow engine downsizing.

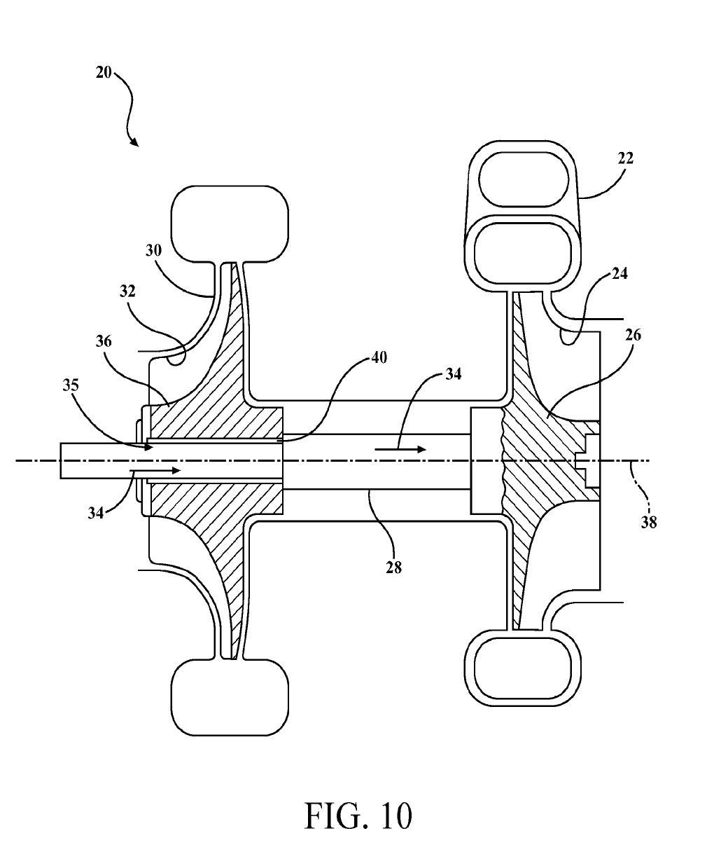

With reference now to the embodiment illustrated in FIGS. 10-20, wherein like numerals indicate like parts throughout the several views, another embodiment of turbocharger 20 is generally shown in FIGS. 10. The turbocharger 20 receives exhaust gas from an internal combustion engine and delivers compressed air to the internal combustion engine. The turbocharger 20 includes a turbine housing 22 defining a turbine housing interior 24. The turbine housing 22 receives and directs exhaust gas from the internal combustion engine. The turbocharger 20 includes a turbine wheel 26 within the turbine housing interior 24 for receiving the exhaust gas from the internal combustion engine. Specifically, the exhaust gas from the internal combustion engine is used to drive the turbine wheel 26. The turbocharger 20 includes a shaft 28 coupled to and rotatable by the turbine wheel 26. Specifically, the turbine wheel 26 is driven by the exhaust gas from the internal combustion engine, which, in turn, rotates the shaft 28. The shaft 28 extends along an axis 38 that extends longitudinally through the turbine housing interior 24.

The turbocharger 20 includes a compressor housing 30 defining an interior 32 of the compressor housing 30 and a flow path 34. The interior 32 of the compressor housing 30 receives and directs air to the internal combustion engine. The flow path 34 fluidly couples the interior 32 of the compressor housing 30 with the internal combustion engine. The compressor housing 30 includes an air inlet portion 35 which is spaced apart from the shaft 28 and is disposed about the axis 38. The air inlet defines an inlet diameter (ID) which is disposed perpendicular to the axis 38. The turbocharger 20 includes a compressor wheel 36 disposed within the interior 32 of the compressor housing 30 and coupled to the shaft 28. The compressor wheel 36 is disposed between the air inlet portion 35 and the turbine wheel 26. The compressor wheel 36 is rotatable by the shaft 28 for delivering the compressed air to the internal combustion engine through the flow path 34.

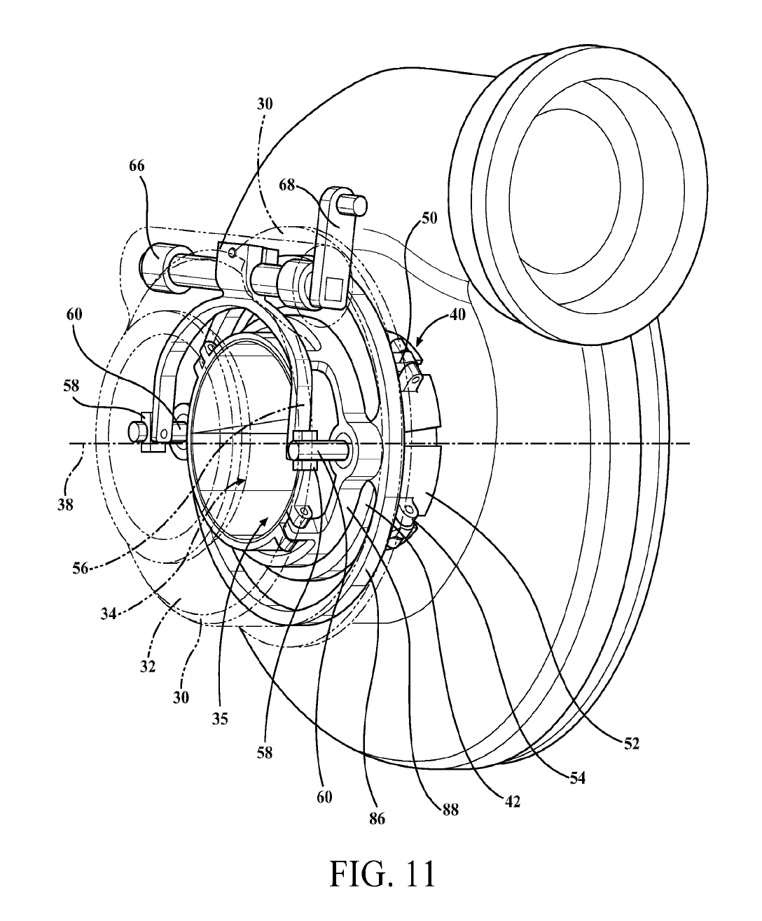

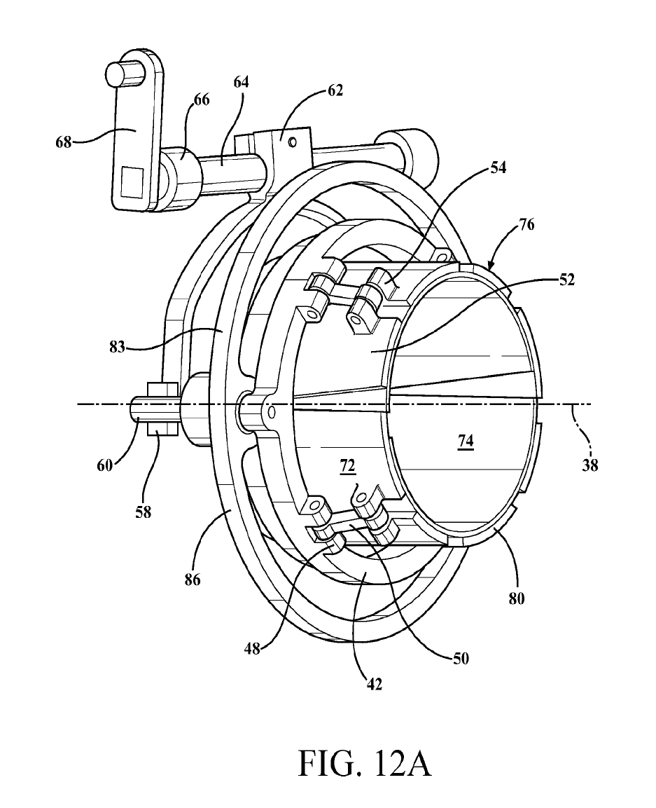

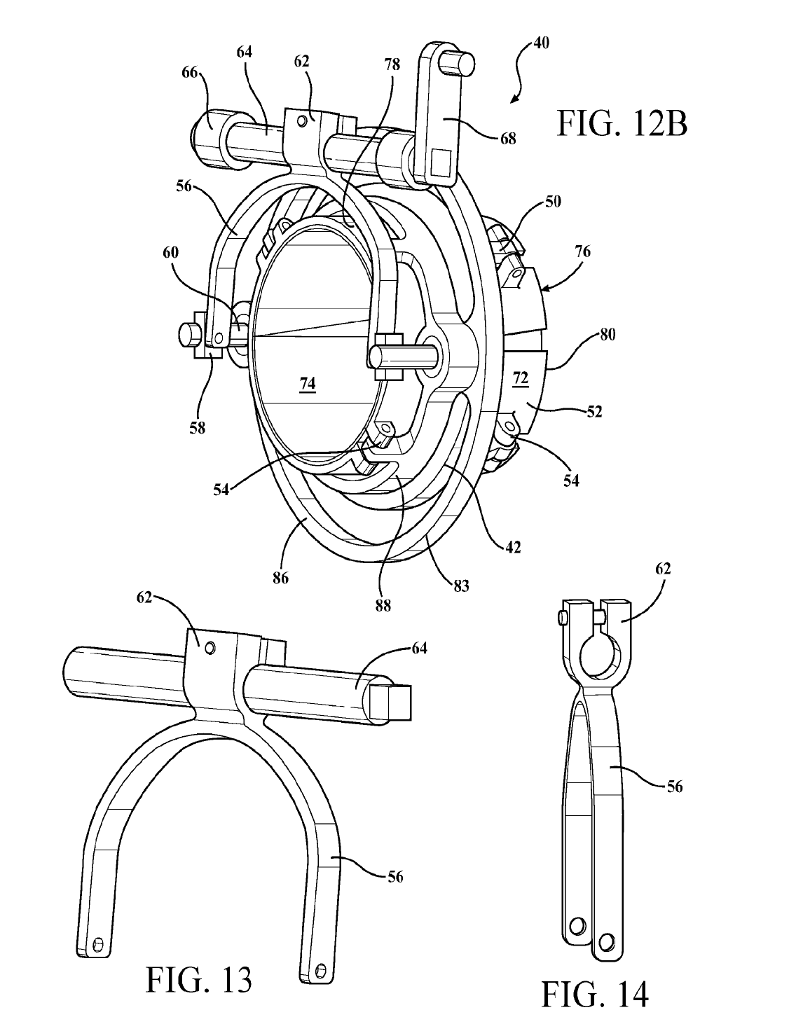

Referring now to FIGS. 11 and 12A-B, the turbocharger 20 also includes an airflow adjustment assembly 40. The airflow adjustment assembly 40 may be disposed at least partially within the interior 32 of the compressor housing 30. It is also contemplated that certain components of the airflow adjustment assembly 40 may be disposed outside of the compressor housing 30. In the embodiment illustrated in FIG. 11, the entire airflow adjustment assembly 40 is disposed within the interior 32 of the compressor housing 30. Moreover, the flow path 34 is disposed parallel with the axis 38 and flows into the airflow adjustment assembly 40 at one end, flows through the airflow adjustment assembly 40 and exits the airflow adjustment assembly 40 at an opposite end where the air continues to flow into the compressor housing 30 towards the internal combustion engine.

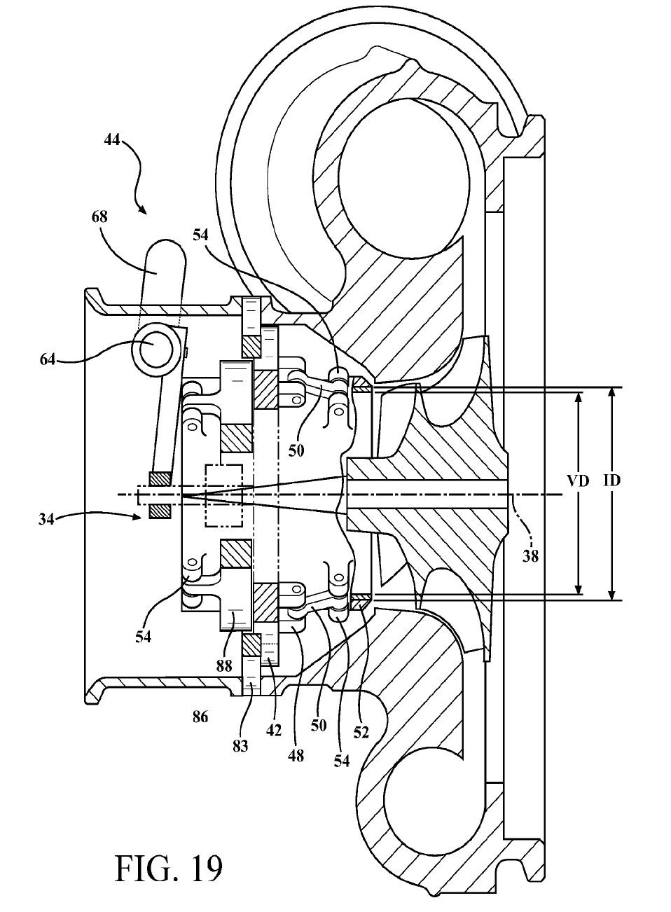

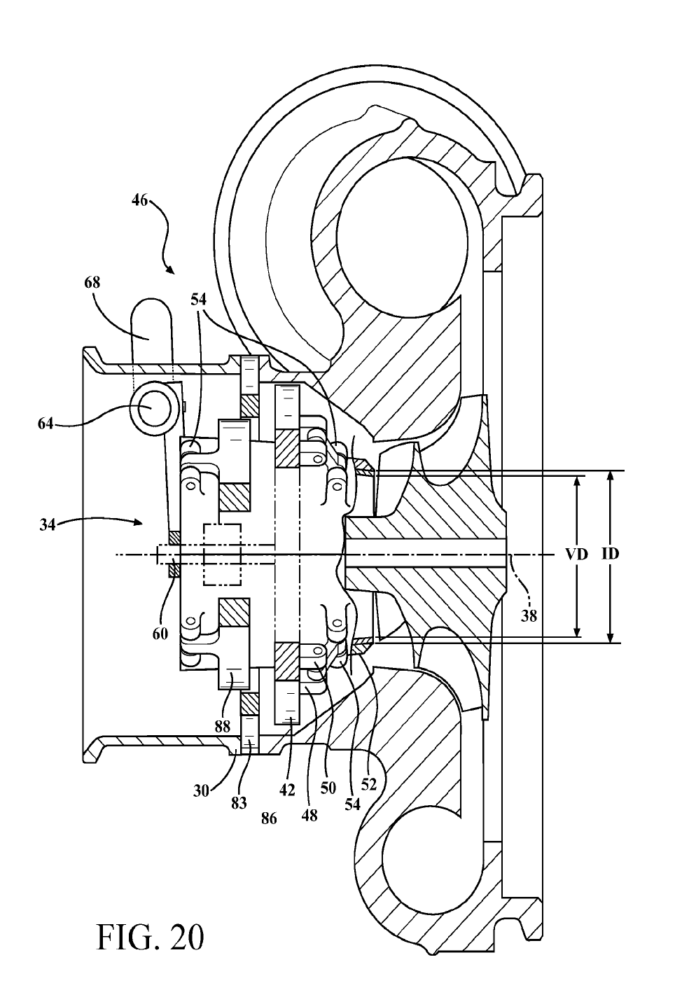

The airflow adjustment assembly 40 includes a sliding ring 42 which is at least partially disposed within the interior 32 of the compressor housing 30. The sliding ring 42 may be comprised of aluminum, steel, a plastic polymer or other material as known by one of ordinary skill in the art. The sliding ring 42 is configured to be axially movable between a first position 44 where air is not restricted from flowing though the interior 32 of the compressor housing 30, and a second position 46 where air is at least partially restricted from flowing through the interior 32 of the compressor housing 30 along the axis 38. As illustrated in the embodiment shown in FIGS. 19 and 20, when the sliding ring 42 is moved towards the first position 44, the sliding ring 42 moves along the axis 38 in the opposite direction of the flow path 34. Moreover, when the sliding ring 42 is moved towards the second position 46, the sliding ring 42 moves along the axis 38 in the same direction as the flow path 34.

Referring again to FIGS. 11 and 12A-B, the sliding ring 42 has a generally circular, ring-like shape having an aperture in the center. In the embodiment illustrated in FIGS. 11 and 12A-B, the sliding ring 42 has a generally flat first surface and second surface which are connected by a curved outer and inner surface forming the ring shape. As shown in FIGS. 11 and 12A-B, the top surface, bottom surface, inner surface, and outer surface generally have a similar width. However, it is contemplated that the widths of any of the surfaces may be larger or smaller than any other surface width of the sliding ring 42. In the embodiment shown in FIGS. 12A-B, the sliding ring 42 is disposed perpendicular to the axis 38 such that the axis 38 is disposed through the aperture in the center of the sliding ring 42. However, it is contemplated that the sliding ring 42 may be various other shapes and/or orientations configured to be axially moveable along the axis 38.

Referring again to the embodiment illustrated in FIGS. 12A-B, the sliding ring 42 may include at least one, and as illustrated in FIGS. 12A-B, a plurality of connecting prongs 48 which extend from the second surface of the sliding ring 42. As such, it is contemplated that the connecting prongs 48 may be made of the same material as the sliding ring 42 or may be made of a different material including but not limited to steel, aluminum, or a plastic polymer as known by one of ordinary skill in the art. In the embodiment shown in FIGS. 12A-B, the connecting prongs 48 extend the entire width of the bottom surface, however, various configurations have been contemplated. The connecting prongs 48 illustrated in FIGS. 12A-B are disposed in pairs about the top surface of the sliding ring 42, having a space between each pair. However, it is also contemplated that the connecting prongs 48 may be disposed at another location of the guide vane as desired by one of ordinary skill in the art. A connecting rod 50 is configured to be disposed in the space between each pair of connecting prongs 48. It is contemplated that a fastener is disposed through the pair of connecting prongs 48 and through the connecting rod 50 to secure the connecting rod 50 to the sliding ring 42. However, it is also contemplated that the connecting rod 50 and the sliding ring 42 may be coupled in various other ways, as known by one of ordinary skill in the art. In the embodiment illustrated in FIGS. 12A-B, the sliding ring 42 includes four pairs in the connecting prongs 48 corresponding to four connecting rods 50; however, any number of connecting prongs 48 and/or connecting rods 50 may be implemented in the airflow adjustment assembly 40.

The connecting rods 50 are at least partially disposed within the interior 32 of the compressor housing 30 and are configured to move in the direction opposite the flow path 34 when the sliding ring 42 is moved to the first position 44 and move in the same direction as the flow path 34 when the sliding ring 42 is moved to the second position 46. More specifically, the connecting rods 50 are axially movable along the axis 38 when the sliding ring 42 moves axially along the axis 38. As illustrated in the embodiment shown in FIGS. 12A-B, the connecting rods 50 have a generally bar-shaped main section having a circular connecting portion on each end. The circular portions are configured to allow the fastener to couple a first circular portion to the connecting prongs 48 of the sliding ring 42. On the opposite end of the connecting rod 50 is another circular portion which may be similar or identical to the first circular portion and is configured to pivotally couple the connecting rod 50 to a guide vane 52. Again, a fastener may be disposed through the circular portion to secure the connecting rod 50 and the guide vane 52. The connecting rods 50 may be comprised of steel, aluminum, or another material having sufficient strength to couple the sliding ring 42 to the guide vane 52 of the air flow adjustment assembly.

As illustrated in the embodiments shown in FIGS. 12A-B, the connecting rods 50 extend from the sliding ring 42 to the guide vane 52 and are configured to define a space between the sliding ring 42 and the guide vanes 52. In the embodiment illustrated in FIGS. 12A-B, the airflow adjustment assembly 40 includes four connecting rods 50, however it is contemplated that more or fewer connecting rods 50 may be disposed between the sliding ring 42 and the guide vanes 52. As additionally illustrated in the embodiment shown in FIGS. 12A-B, a single connecting rod 50 is coupled to each guide vane 52. However, it is additionally contemplated that multiple connecting rods 50 may be coupled to each guide vane 52 as desired by one of ordinary skill in the art.

Referring again to the embodiment shown in FIGS. 12A-B, the connecting rods 50 are coupled to the guide vanes 52 at a first set of connecting protrusion 54 of the guide vane 52. As illustrated in FIGS. 12A-B, the first set of connecting protrusion 54 is comprised of a pair of protrusions configured to have the connecting rod 50 disposed between the pair of protrusions. The fastener is then disposed through each protrusion and the circular portion of the connecting rod 50 to pivotally couple the guide vane 52 to the connecting rod 50. Various other configurations have also been contemplated which allow the connecting rod 50 and the guide vane 52 to be pivotally coupled to one another without departing from the spirit of the invention. Moreover, it is contemplated that the sliding ring 42 and the guide vane 52 may be coupled to one another using another mechanism without departing from the spirit of the invention. As additionally illustrated in FIGS. 12A-B, the first set of connecting protrusions 54 are disposed between a guide base 78 and a guide tip 80 of the guide vane 52. However, it is additionally contemplated that the first set of connecting protrusions 48 may be disposed along any portion of the guide vane 52.

The sliding ring 42 is additionally coupled to a yoke 56 which is at least partially disposed with the interior 32 of the compressor housing 30. As illustrated in FIGS. 11 and 12A-B, the yoke 56 may have a generally semi-circle shape and is disposed in the direction opposite the direction of airflow from the sliding ring 42. The yoke 56 is pivotally coupled to the sliding ring 42 and configured to move the sliding ring 42 axially along the axis 38 between the first position 44 and the second position 46. It is contemplated that the yoke 56 may be a variety of other shapes or configurations configured to be pivotally coupled to the sliding ring 42 as known by one of ordinary skill in the art. The yoke 56 is typically comprised of the same material as the sliding ring 42 such as steel, aluminum or aluminum alloy, or a plastic polymer. However, the yoke 56 may be comprised of any other material as desired by one of ordinary skill in the art.

As shown in the embodiment illustrated in FIGS. 12A-B, 13 and 15, the yoke 56 has a coupler 58 disposed on each distal end of an inside surface of the yoke 56. Each of the couplers 58 are configured to engage a connecting pin 60 which pivotally couples the sliding ring 42 and the yoke 56. It is contemplated that the coupler 58 is configured to allow the yoke 56 to tilt in a direction opposite the direction of the flow path 34 to move the sliding ring 42 from the first position 44 to the second position 46. More specifically, a top portion of the yoke 56 which is disposed along the semi-circle between the two distal ends of the yoke, is configured to move in the direction opposite the direction of the flow path 34 while the ends of the yoke 56 move in the direction of the flow path 34 to move the connecting pins 60 which move the sliding ring 42 from the first position 44 to the second position 46.

Referring again to the embodiment illustrated in FIGS. 12A-B, 13, and 14, the yoke 56 is coupled to the sliding ring 42 using the connecting pins 60 and the couplers 58. It is contemplated that two connecting pins 60 may couple the sliding ring 42 and the yoke 56 as illustrated in FIGS. 12A-B; however, more or less connecting pins 60 may be used as desired by one of ordinary skill in the art. As also illustrated in FIGS. 12A-B, the connecting pins 60 may be coupled to the sliding ring 42 through guide bushings. However, it is contemplated that the connecting pins 60 may be coupled to the sliding ring 42 using another method as known by one of ordinary skill in the art. It is also contemplated that the yoke 56 is coupled to the sliding ring 42 using another connection method other than the coupler 58/connecting pin 60 mechanism as described above, as known by one of ordinary skill in the art.

As illustrated in the embodiment shown in FIGS. 12A-B, 13, and 14 the yoke 56 may include a rectangular tab 62 disposed approximately equidistant between the two distal ends of the yoke 56 along the semi-circle. The rectangular tab 62 is configured to engage a cross-shaft 64. The cross-shaft 64 may be composed of steel, aluminum or aluminum alloy, a plastic polymer, or any other material as known by one of ordinary skill in the art. As illustrated in the embodiment shown in FIGS. 12A-B, the cross-shaft 64 is disposed perpendicular to the axis 38 and is fixed to the rectangular tab 62 of the yoke 56. As illustrated in the embodiment shown in FIGS. 12A-B, 13, and 14, the rectangular tab 62 of the yoke 56 may include an aperture configured to allow a portion of the cross-shaft 64 to be disposed through the aperture. Moreover, the rectangular tab 62 may include a gap disposed above the aperture which allows the cross-shaft 64 to be inserted into the aperture. As illustrated in the embodiment shown in FIGS. 12A-B, 13, and 14, the gap may be closed or fixed be a fastener. It is also contemplated that the cross-shaft 64 and yoke 56 may be fixed in any other configuration as known by one of ordinary skill in the art including but not limited to having the cross-shaft 64 and the yoke 56 being a single integral piece.

As additionally illustrated in the embodiment shown in FIGS. 12A-B, 13, and 14 the cross-shaft 64 is typically a cylindrical rod having two ends. However, it is contemplated that the cross-shaft 64 may be rectangular, triangular, or any other shape as desired by one of ordinary skill in the art. It is also contemplated that, as illustrated in FIGS. 12A-B, 13, and 14 the cylindrical rod portion of the cross-shaft 64 may have an indented portion. The indented portion may extend around the entire circumference of the cross-shaft 64 or may only extend around a portion of the circumference of the cross-shaft 64, as illustrated in FIGS. 12A-B. The yoke 56 may also be attached to the cross shaft 64 by having a through hole or aperture disposed in the yoke 56 which is configured to allow the cross-shaft 64 to pass directly through the yoke 56, as described above. Additionally, it is contemplated that the cross shaft 64 and the yoke 56 may be coupled using a clamp, an interference fit, or another connection method as known by one of ordinary skill in the art. Each end of the cross-shaft 64 may include a bushing 66 as illustrated in FIGS. 12A-B, or may include another connection feature allowing the cross-shaft 64 to be coupled to another device.

In the embodiment illustrated in FIGS. 12A-B, one end of the cross-shaft 64 includes an actuation mechanism 68. The actuation mechanism 68 is configured to be actuated by an actuation assembly or other mechanism. When actuated, the actuation mechanism 68 is configured to rotate which in turn pulls the rectangular tab 62 of the yoke 56 such that the yoke 56 tilts and in turn moves the sliding ring 42 axially along the axis 38 from the first position 44 to the second position 46. The actuation mechanism 68 is typically comprised of steel, however the actuation mechanism 68 may be comprised of another material which has the strength required to rotate the cross-shaft 64, as known by one of ordinary skill in the art. As illustrated in the embodiment shown in FIGS. 12A-B, the actuation mechanism 68 has a rectangular bottom portion which extends towards a rounded upper portion which includes an engagement protrusion for engaging another mechanism for actuation of the cross-shaft 64. However, it is contemplated that the actuation mechanism 68 may be any other shape or configuration as desired by one of ordinary skill in the art, including but not limited to a gear or a control lever which may be actuated by a pneumatic actuator or vacuum actuator or other actuator has known by one of ordinary skill in the art.

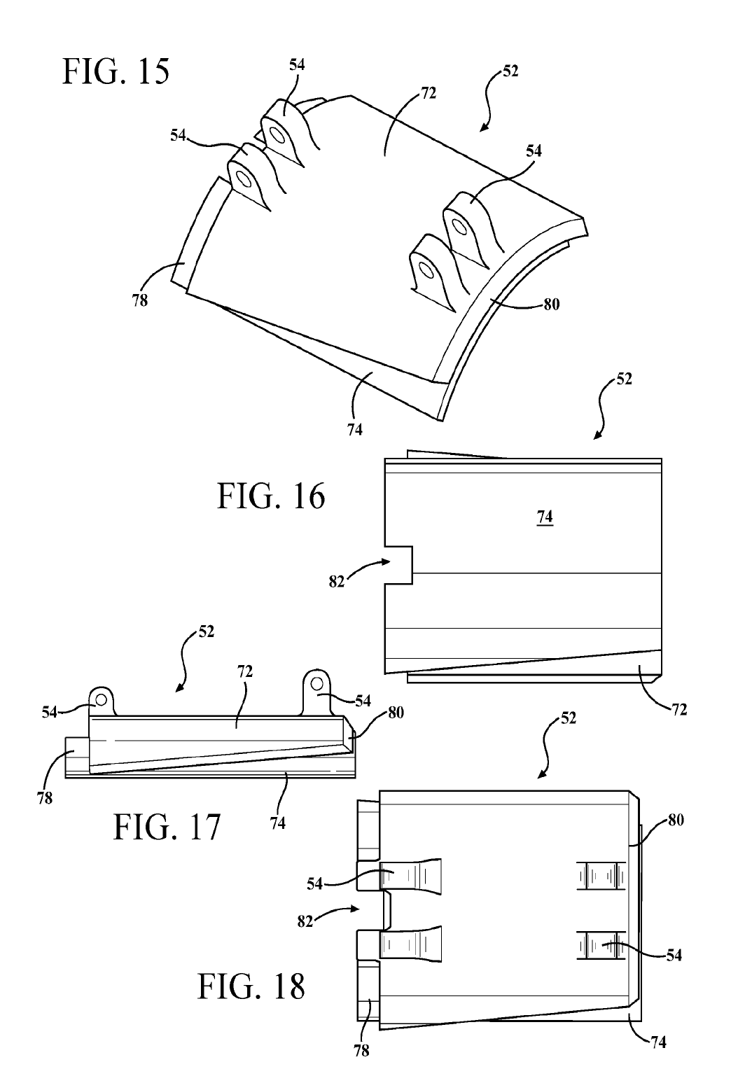

Referring now to the embodiment shown in FIGS. 15-18, the guide vanes 52 are at least partially disposed within the interior 32 of the compressor housing 30. The guide vanes 52 are generally comprised of steel, aluminum or aluminum alloy, a plastic polymer, or another material as known by one of ordinary skill in the art. Additionally, the guide vanes 52 have a separate outer surface 72 and an inner surface 74. However, it is also contemplated that the guide vanes 52 may be comprised of a single piece without departing from the spirit of the invention. It is contemplated that the outer surface 72 and inner surface 74 may be comprised of the same material or the outer surface 72 and the inner surface 74 may be comprised of different materials from one another. Both the outer surface 72 and the inner surface 74 of each guide vane 52 are configured to form a seal between each of the guide vanes 52 when the sliding ring 42 is in the first position 44 and when the sliding ring 42 is in the second position 46.

As illustrated in the embodiment shown in FIGS. 15-18, each guide vane 52 may be disposed within the interior 32 of the compressor housing 30. In the embodiment illustrated in FIGS. 10-20, the guide vanes 52 are curved slightly and disposed adjacent to one another, forming a guide drum 76. More specifically, the guide vanes 52 are curved such that the guide vanes 52 are disposed circumferentially about the axis 38 such that the guide vanes 52 form a circle having the axis 38 disposed through the center. In the embodiment illustrated in FIGS. 12A-B, four guide vanes 52 are disposed about the axis 38 forming the guide drum 76. However, it is contemplated that more or less guide vanes 52 may comprise the guide drum 76. Further, the inner surfaces 74 of the guide vanes 52 define an interior of the guide drum 76 which the flow path 34 flows through. Additionally, each of the guide vanes 52 have a guide tip 80 and a guide base 78, where each of the guide bases 78 are pivotally coupled to the air inlet portion 35. The guide base 78 is spaced from the guide tip 80 along the axis 38. The guide tips 80 of the guide vanes 52 define a vane diameter (VD). The vane diameter (VD) is measured from the inner surface 74 of one guide vane 52 to the inner surface 74 of an opposite guide vane 52 and is disposed perpendicular to the axis 38. Moreover, the vane diameter (VD) is less than the inlet diameter (ID). Additionally, the vane diameter (VD) is configured to be increased when the sliding ring 42 is moved to the first position 44 and to be decreased when the sliding ring 42 is moved to the second position 46.

Referring again to the embodiment illustrated in FIGS. 15-18, the inner surface 74 and outer surface 72 are separate surfaces and are disposed against each other, i.e. a top surface of the inner surface 74 is disposed against the bottom surface of the outer surface 72. Each of the inner surface 74 and the outer surface 72 have four sides. The first side, the second side, and the third side form three sides of a rectangle such that the first side and the second side are disposed parallel to one another and the third side is disposed at approximately a 90 degree angle to both the first and second side. The fourth side connects the first side and the second side, however, the fourth side is angled such that the first side has a length that is longer than the second side. Additionally, the first side includes may include an indent 82, as illustrated in FIGS. 15-18, which is configured to allow a support ring 83 to be disposed between the pair of connecting prongs 48 and coupled to the guide base 78. It is also contemplated that the guide base 78 may not include an indent 82 such that the support ring 83 is coupled to the guide vane 52 using another configuration.

As illustrated best in FIGS. 15, 16, and 18 the outer surface 72 and the inner surface 74 are arranged offset from one another such that the angled or fourth side of the outer surface 72 is matched up with the first side, or side parallel to the axis 38, of the inner surface 74. In other words, a portion of the inner surface 74 is visible from a top view, as illustrated in FIG. 18, and a portion of the outer surface 72 is visible when viewed from a bottom view, as illustrated in FIG. 17. This configuration allows the guide drum 76 to have an air-tight seal between guide vanes 52 when the sliding ring 42 is in the first position 44 and when the sliding ring 42 is in the second position 46. Additionally, this configuration may also provide an air tight seal between the guide vanes 52 when the sliding ring 42 is being moved from the first position 44 to the second position 46 and when the sliding ring 42 is being moved from the second position 46 to the first position 44. It is additionally contemplated that various other configurations of the guide vanes 52 may be implemented which provide an air-tight seal of the guide drum 76.

As illustrated in the embodiment shown in FIGS. 12A-B, the support ring 83 is disposed about the guide drum. In other words, the support ring 83 includes an aperture which has the guide drum disposed there through. However, it is also contemplated that the support ring 83 may be disposed such that the aperture is before or after the guide drum in the direction of the flow path. Moreover, as illustrated in FIGS. 12A-B the support ring 83 comprises multiple rings, and in the embodiment shown two rings. The outer ring 86 has a ring-shape and is disposed approximately equally from each point of the guide drum. Moreover, the outer ring 86 is configured to engage the compressor housing and provide support to the housing while allowing access to the compressor interior for installation assembly and repair of the compressor and of the airflow adjustment assembly. The inner ring 88 of the support ring 83 is configured to be coupled to the guide drum. In the embodiment illustrated in FIGS. 12A-B, the inner ring 88 includes prongs extending from the inner ring 88 which are configured to engage with the connecting prongs 48 disposed on the guide base of the guide vane. However, it is additionally contemplated that the support ring 83 may be coupled to the guide drum, or another portion of the airflow adjustment assembly by another method as known by one of ordinary skill in the art. As additionally illustrated in FIGS. 12A-B, the inner ring 88 and the outer ring 86 may be coupled to one another by a connecting portion. The connecting portion may also include an aperture which is configured to allow the connecting pin 60 to be disposed there through. As illustrated in the embodiment shown in FIGS. 12A-B, the connecting pin 60 is disposed from the coupler 58 of the yoke 56, through the aperture of the connecting portion of the support ring 83 where the connecting pin 60 is then coupled to the sliding ring 42. It is also contemplated that the support ring 83 may be coupled to the sliding ring 42 or another portion of the airflow adjustment assembly 40 by another method as known by one of ordinary skill in the art. Moreover, it is contemplated that the support ring 83 is stationary when the sliding ring 42 is moved to the first position 44 and when the sliding ring 42 is moved to the second position 46. However, it is contemplated that the support ring 83 may be movable such that the support ring 83 moves or slides when the sliding ring 42 is moved from the first position 44 to the second position 46 or from the second position 46 to the first position 44.

As best illustrated in FIGS. 15 and 17, the connecting protrusions 54 of the guide vane 52 are coupled to either the inner surface 74 or the outer surface 72 of the guide vane 52. However, it is also contemplated that the connecting protrusions 54 of the guide vane 52 are coupled to both the inner surface 74 and the outer surface 72 of the guide vane 52. As additionally illustrated in FIGS. 12A-B, the airflow adjustment assembly may include at least two sets of connecting protrusions 54. The first set of connecting protrusions 54 are coupled to the connecting rods 50 and the sliding ring 42 and are configured to move both the inner surface 74 and the outer surface 72 of guide vane 52 as one piece when the sliding ring 42 is moved between the first position 44 and the second position 46. It is also contemplated that the inner surface 74 and the outer surface 72 could be moved separately if desired by one of ordinary skill in the art. As illustrated in FIGS. 12A-B, the first set of connecting protrusions 54 of the guide vane 52 are disposed between the guide base 78 and the guide tip 80. In the embodiment illustrated in FIGS. 12A-B, the first set of the connecting protrusions 54 of the guide vane 52 are disposed approximately halfway between the guide base 78 and the guide tip 80. However, it is additionally contemplated that various other configurations of the guide vane 52 and connecting protrusions 54 may be implemented without departing from the spirit of the invention which allow the inner surface 74 and the outer surface 72 of the guide vanes 52 to be coupled to the connecting rods 50.

As illustrated in the embodiment shown in FIGS. 12A-B, the second set of connecting protrusions 54 are disposed at the guide base 78 of the guide vane 52. Again, it is contemplated that the connecting protrusions 54 may be made of the same material as the guide vane 52 or may be made of a different material including but not limited to steel, aluminum, or a plastic polymer as known by one of ordinary skill in the art. Moreover, the second set of connecting protrusions 54 disposed in pairs about the top surface of the guide vane 52, having a space between each pair. As illustrated in FIGS. 12A-B, a portion of the support ring 83 is disposed between the second set of connecting protrusions 54 and the support ring 83 and the connecting protrusions 54 may be secured by a fastener in a similar fashion as described above. However, it is also contemplated that the support ring 83 and the connecting protrusions 54 may be coupled in various other ways, as known by one of ordinary skill in the art. In the embodiment illustrated in FIGS. 12A-B, the guide vane includes four pairs in the second set of connecting protrusions 54 corresponding to four connecting portions of the support ring 83; however, any number of connecting protrusions 54 may be implemented in the airflow adjustment assembly 40. As additionally illustrated in FIGS. 12A-B, the second set of connecting protrusions 54 are disposed on the guide base of the guide vane 52. However, it is also contemplated that the second set of connecting protrusions 54 may be disposed on any portion of the guide vane 52.

Referring now to the embodiment shown in FIGS. 19 and 20, in operation, the sliding ring 42 begins in the first position 44 shown in FIG. 19. When the sliding ring 42 is in the first position 44, the yoke 56 is disposed perpendicular to the axis 38 while the actuation mechanism 68 of the cross-shaft 64 is not actuated, as illustrated in FIG. 19. However, it is also contemplated that when the sliding ring 42 is in the first position 44, the yoke 56 may be disposed at an angle which is negative or positive relative to the axis. Additionally, when the sliding ring 42 is in the first position 44, the vane diameter (VD) is at its largest such that the air flow is not restricted in the flow path 34 through the airflow adjustment device. As illustrated in FIG. 19, the vane diameter (VD) is at its largest when the guide vanes 52 extend parallel to axis 38, however, it is also contemplated that the largest diameter may occur when the guide vanes 52 extend at an angle either above parallel to the axis 38. When desired, the actuation mechanism 68 may be activated by any actuator as known by one of ordinary skill in the art. When the actuation mechanism 68 is activated, the cross-shaft 64 rotates which moves the yoke 56. The yoke 56 is moved or tilted to an angle which may be positive or negative relative to the axis 38. The angle may be a slight angle such as between 5 and 15 degrees or may be a bigger angle such as between 5 and 45 degrees. It is additionally contemplated that the yoke 56 may be rotated up to 90 degrees as desired by one of ordinary skill in the art. Moreover, it is also contemplated that any of the angles described may be negative angles with respect to the position of the yoke 56 when the sliding ring 42 is in the first position 44. When the yoke 56 is moved, the connecting pins 60 push the sliding ring 42 in a direction of the flow path 34 along the axis 38 and into the second position 46. In the second position 46, the sliding ring 42 engages the connecting rods 50 which allow the guide vanes 52 to pivot towards the center of the guide drum 76 such that the vane diameter (VD) is decreased. As illustrated in FIG. 20, when the sliding ring 42 is in the second position 46 the vane diameter (VD) is decreased from when the sliding ring 42 is in the first position 44 such that the air is at least partially restricted from flowing through the interior 32 of the compressor along the flow path 34. When the sliding ring 42 is in the first position 44 and when the sliding ring 42 is in the second position 46, the guide vanes 52 are sealed to one another such that no air escapes between the guide vanes 52 and all of the air entering the airflow adjustment assembly 40 moves through the airflow adjustment assembly 40 and exits the airflow adjustment assembly 40 to the compressor housing 30.

It is also contemplated that, when desired, the sliding ring 42 can be moved from the second position 46 to the first position 44. To achieve this, the actuation mechanism 68 of the cross-shaft 64 may be engaged by a mechanism which rotates the cross-shaft 64 to the position illustrated in FIG. 19. The yoke 56 is then moved to be perpendicular to the axis 38. The connecting pins 60 pull the sliding ring 42 to the first position 44. When the sliding ring 42 is moved to the first position 44, the connecting rods 50 are engaged and pivot the guide vanes 52 away from the center of the guide drum 76 until the vane diameter (VD) is at its largest. Moreover, it is contemplated that the vane diameter (VD) may be held in any position between the position corresponding with the first position 44 of the sliding ring 42 and the position corresponding with the second position 46 of the sliding ring 42. As illustrated in the Figures, the sliding ring 42 is disposed about the guide drum 76 in both the first position 44 and the second position 46.

One advantage of controlling the vane diameter (VD) is to achieve higher pressure ratios at a low engine speed. This improves the map width of a single compressor and increases the surge line of the compressor which allows better operating efficiency of the compressor and better intake throttling. By controlling the vane diameter (VD) in a single stage compressor by the method and apparatus described above, a similar performance of a multiple stage compressor may be achieved with the space saving advantages that come with a single stage compressor. The apparatus and method as described above also allow the turbocharger to achiever higher Exhaust Gas Recirculation (EGR) rates without impacting power rating. Additionally, the apparatus as described above may increase Low End Torque (LET) which would allow engine downsizing.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. A turbocharger for receiving exhaust gas from an internal combustion engine and for delivering compressed air to the internal combustion engine, said turbocharger comprising:
a turbine housing defining a turbine housing interior;
a turbine wheel disposed within said turbine housing interior for receiving the exhaust gas from the internal combustion engine;
a turbocharger shaft coupled to and rotatable by said turbine wheel, with said turbocharger shaft extending along an axis that extends longitudinally through said turbine housing interior;
a compressor housing defining an interior, with said compressor housing having an air inlet portion spaced from said turbocharger shaft and disposed about said axis, and with said air inlet defining an inlet diameter (ID) perpendicular to said axis;
a compressor wheel disposed within said interior and coupled to said turbocharger shaft, with said compressor wheel being rotatable by said turbocharger shaft for delivering compressed air to said air inlet portion and said turbine wheel; and
an airflow adjustment assembly comprising,
a plurality of guide vanes at least partially disposed within said interior of said compressor, with each of said plurality of guide vanes having a guide tip and a guide base spaced from said guide tip along said axis, with each of said guide bases pivotably coupled to said air inlet portion, and with each of said guide tips defining a vane diameter (VD) less than said inlet diameter (ID) and perpendicular to said axis,
a sliding ring at least partially disposed within said interior of said compressor and axially moveable along said axis, and
a plurality of connecting rods at least partially disposed within said interior of said compressor, with each of said plurality of connecting rods disposed between and coupled to one of said plurality of guide vanes and said sliding ring; wherein said plurality of connecting rods are axially moveable along said axis when said sliding ring moves axially along said axis, thereby selectively increasing and/or decreasing said vane diameter (VD) when said sliding ring moves axially along said axis.

2. The turbocharger as set forth in claim 1, wherein said connecting rods are coupled to one of said plurality of guide vanes at said guide base.

3. The turbocharger as set forth in claim 1, wherein said sliding ring moves between a first position where air is not restricted from flowing through said interior of said compressor housing and a second position where air is at least partially restricted from flowing through said interior of said compressor housing along said axis.

4. The turbocharger as set forth in claim 3, wherein said vane diameter (VD) is decreased when said sliding ring is moved from said first position to said second position and said vane diameter (VD) is increased when said sliding ring is moved from said second position to said first position.

5. The turbocharger as set forth in claim 3, wherein said plurality of guide vanes each include a separate inner surface and outer surface configured to seal said plurality of guide vanes when said sliding ring is in said first position and in said second position.

6. The turbocharger as set forth in claim 1, further comprising a yoke at least partially disposed within said interior of said compressor housing and pivotally coupled to said sliding ring for moving said sliding ring along said axis.

7. The turbocharger as set forth in claim 6, further comprising a cross-shaft extending perpendicular to said axis and fixed to said yoke for pivoting said yoke to move said sliding ring along said axis.

8. The turbocharger as set forth in claim 5, wherein said inner surface of said plurality of said guide vanes and said outer surface of said plurality of said guide vanes are arranged offset from one another for sealing said plurality of guide vanes when said sliding ring is in said first position and when said sliding ring is in said second position.

9. The turbocharger as set forth in claim 1, wherein said plurality of guide vanes comprise a guide drum and said sliding ring is disposed about said guide drum.

10. A turbocharger for receiving exhaust gas from an internal combustion engine and for delivering compressed air to the internal combustion engine, said turbocharger comprising:
a turbine housing defining a turbine housing interior;
a turbine wheel disposed within said turbine housing interior for receiving the exhaust gas from the internal combustion engine;
a turbocharger shaft coupled to and rotatable by said turbine wheel, with said turbocharger shaft extending along an axis that extends longitudinally through said turbine housing interior;
a compressor housing defining an interior, with said compressor housing having an air inlet portion spaced from said turbocharger shaft and disposed about said axis, and with said air inlet defining an inlet diameter (ID) perpendicular to said axis;
a compressor wheel disposed within said interior and coupled to said turbocharger shaft, with said compressor wheel being rotatable by said turbocharger shaft for delivering compressed air to said air inlet portion and said turbine wheel; and
an airflow adjustment assembly comprising,
a plurality of guide vanes at least partially disposed within said interior of said compressor, with each of said plurality of guide vanes having a guide tip and a guide base spaced from said guide tip along said axis, with each of said guide bases pivotably coupled to said air inlet portion, and with each of said guide tips defining a vane diameter (VD) less than said inlet diameter (ID) and perpendicular to said axis,
a sliding ring at least partially disposed within said interior of said compressor and axially moveable along said axis, and
a plurality of connecting rods at least partially disposed within said interior of said compressor, with each of said plurality of connecting rods disposed between and coupled to one of said plurality of guide vanes between said guide base and said guide tip and said sliding ring; wherein said plurality of connecting rods are axially moveable along said axis when said sliding ring moves axially along said axis, thereby selectively increasing and/or decreasing said vane diameter (VD) when said sliding ring moves axially along said axis.

11. The turbocharger as set forth in any one of claim 10, wherein said sliding ring moves between a first position where air is not restricted from flowing through said interior of said compressor housing and a second position where air is at least partially restricted from flowing through said interior of said compressor housing along said axis.

12. The turbocharger as set forth in claim 11, wherein said vane diameter (VD) is decreased when said sliding ring is moved from said first position to said second position and said vane diameter (VD) is increased when said sliding ring is moved from said second position to said first position.

13. The turbocharger as set forth in claim 12, wherein said plurality of guide vanes each include a separate inner surface and outer surface configured to seal said plurality of guide vanes when said sliding ring is in said first position and in said second position.

14. The turbocharger as set forth claim 10, further comprising a yoke at least partially disposed within said interior of said compressor housing and pivotally coupled to said sliding ring for moving said sliding ring along said axis.

15. The turbocharger as set forth in claim 14, further comprising a cross-shaft extending perpendicular to said axis and fixed to said yoke for pivoting said yoke to move said sliding ring along said axis.

16. The turbocharger as set forth in claim 13, wherein said inner surface of said plurality of said guide vanes and said outer surface of said plurality of said guide vanes are arranged offset from one another for sealing said plurality of guide vanes when said sliding ring is in said first position and when said sliding ring is in said second position.

17. The turbocharger as set forth in claim 10, wherein said plurality of guide vanes comprise a guide drum and said sliding ring is disposed about said guide drum.
